(19) United States
(12) Patent Application Publication
(10) Pub. No.: US 2026/0025381 A1
(43) Pub. Date: Jan. 22, 2026

(54) PERFORM USER VALIDATION USING LOCAL RESOURCES

(71) Applicant: Kyndryl, Inc., New York, NY (US)

(72) Inventors: Cesar Augusto Rodriguez Bravo, Alajuela (CR); Chris Bode, Holly Springs, NC (US); Kim A. Eckert, Austin, TX (US)

(21) Appl. No.: 18/777,854

(22) Filed: Jul. 19, 2024

(51) Int. Cl. H04L 9/40

(52) U.S. Cl. CPC H04L 63/10; H04L 63/08

(57) ABSTRACT

Embodiments relate to performing user validation using local resources in order to permit or deny access to computer resources. An aspect includes in response to receiving a request for access, selecting a selected resource type from a plurality of resource types and selecting a selected user resource from a user resource pool, the selected user resource having the selected resource type. An aspect includes executing a machine learning model to output a prompt in response to inputting the selected user resource, executing a generative artificial intelligence (AI) engine to output generated resources in response to inputting the prompt, and performing an authentication by presenting the generated resources and the selected user resource.

### BACKGROUND

The present invention generally relates to computer systems, and more specifically, to computer-implemented methods, computer systems, and computer program products configured and arranged to perform user validation using local resources in order to permit or deny access to computer resources.

Authentication is the act of proving an assertion, such as the identity of a computer system user, in order to gain access to computer resources including software and hardware. Security research has determined that for a positive authentication, elements from at least two factors of the three should be verified. The three factors (classes) and some of the elements of each factor are the following. Knowledge: something the user knows (e.g., a password, partial password, passphrase, personal identification number (PIN), challenge-response (the user must answer a question or pattern), security question). Ownership: something the user has (e.g., wrist band, identification (ID) card, security token, implanted device, cell phone with a built-in hardware token, software token, or cell phone holding a software token). Inherence: something the user is or does (e.g., fingerprint, retinal pattern, DNA sequence (there are assorted definitions of what is sufficient), signature, face, voice, unique bio-electric signals, or other biometric identifiers).

Single-factor authentication, as the weakest level of authentication, is only a single component from one of the three categories of factors and is used to authenticate an individual's identity. The use of only one factor does not offer much protection from misuse or malicious intrusion. Multi-factor authentication involves two or more authentication factors (something you know, something you have, or something you are). Two-factor authentication is a particular case of multi-factor authentication involving exactly two factors.

### SUMMARY

Embodiments of the present invention are directed to computer-implemented methods for performing user validation using local resources in order to permit or deny access to computer resources. A non-limiting computer-implemented method includes, in response to receiving a request for access, selecting a selected resource type from a plurality of resource types and selecting a selected user resource from a user resource pool, the selected user resource having the selected resource type. The method includes executing a machine learning model to output a prompt in response to inputting the selected user resource, executing a generative artificial intelligence (AI) engine to output generated resources in response to inputting the prompt, and performing an authentication by presenting the generated resources and the selected user resource.

Other embodiments of the present invention implement features of the above-described methods in computer systems and computer program products.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a block diagram of an example computer system for use in conjunction with one or more embodiments of the present invention;

FIG. 2 depicts a block diagram of an example system configured to perform user validation using local resources in order to permit or deny access to computer resources according to one or more embodiments of the present invention;

FIGS. 3A and 3B are a flowchart of a computer-implemented method for dynamically performing user validation using local resources in order to permit or deny access to computer resources according to one or more embodiments of the present invention;

FIG. 4 depicts a flowchart of a computer-implemented method for acquiring local resources according to one or more embodiments of the present invention;

FIG. 5 depicts a block diagram of an example of generating a prompt based on an original user resource according to one or more embodiments of the present invention;

FIG. 6 depicts a block diagram of generating resources of the same type as an original user resource according to one or more embodiments of the present invention;

FIG. 7 depicts a block diagram of example generated resources according to one or more embodiments of the present invention;

FIG. 8 depicts a block diagram of an example graphical presentation for a challenge-response test of generated resources and the original user resource according to one or more embodiments of the present invention;

FIG. 9 is a flowchart of a computer-implemented method for dynamically performing user validation using local resources in order to permit or deny access to computer resources according to one or more embodiments of the present invention;

FIG. 10 depicts a cloud computing environment according to one or more embodiments of the present invention; and

FIG. 11 depicts abstraction model layers according to one or more embodiments of the present invention.

### DETAILED DESCRIPTION

One or more embodiments are configured and arranged to dynamically perform user validation using local resources in order to permit or deny access to computer resources. One or more embodiments provide a system for user validation or authentication as one of the components in cybersecurity. The user validation can be used to perform a password reset, to initiate an authentication request, to access computer resources, etc., thereby helping to improve cybersecurity.

Cybersecurity is the practice of protecting computer systems, networks, and programs from digital attacks. These cyberattacks are usually aimed at accessing, changing, or destroying sensitive information; extorting money from users via ransomware; and/or interrupting normal computing processes. Implementing effective cybersecurity measures is particularly challenging because there are more electronic devices than people, and cyber attackers are becoming more innovative, all of which resorts in a cat/mouse game.

One or more embodiments disclose a system that leverages local and/or user cloud resources, such as images, audio, videos, calendar entries, files, etc., personal to the user/requester combined with the benefits of a generative artificial intelligence (AI) engine to validate a given user on a user device. By leveraging the user's own resources located on the user device and/or on their cloud to perform basic authentication, the system creates artificial resources to be used as distractors for an attacker when presenting choices to the user for validation. The system retrieves characteristics from the selected resource and uses the characteristics from the selected resource to create a tailor-made prompt to create better artificial resources (distractors). The system presents to the user the artificially created resources and a user owned resource to perform the validation. Upon the user owned resource being selected, the user is granted access to the protected computer resource. In contrast, upon one of the artificially created resources being selected, the user is denied access to the protected computer resource and security actions are executed. According to one or more embodiments, the system monitors the behavior of the user device during the creation and presentation of the authentication mechanism in order to detect and prevent potential actions attempting to bypass the integrity and confidentiality of the system. The system performs the validation by contrasting the user selection against the presented options, where the correct option(s) is one of the user's own resources.

One or more embodiments described herein can utilize machine learning techniques to perform tasks, such as classifying a feature of interest. More specifically, one or more embodiments described herein can incorporate and utilize rule-based decision making and artificial intelligence (AI) reasoning to accomplish the various operations described herein, namely classifying a feature of interest. The phrase “machine learning” broadly describes a function of electronic systems that learn from data. A machine learning system, engine, or module can include a trainable machine learning algorithm that can be trained, such as in an external cloud environment, to learn functional relationships between inputs and outputs, and the resulting model (sometimes referred to as a “trained neural network,” “trained model,” “a trained classifier,” and/or “trained machine learning model”) can be used for classifying a feature of interest, for example. In one or more embodiments, machine learning functionality can be implemented using an Artificial Neural Network (ANN) having the capability to be trained to perform a function. In machine learning and cognitive science, ANNs are a family of statistical learning models inspired by the biological neural networks of animals, and in particular the brain. ANNs can be used to estimate or approximate systems and functions that depend on a large number of inputs. Convolutional Neural Networks (CNN) are a class of deep, feed-forward ANNs that are particularly useful at tasks such as, but not limited to analyzing visual imagery and natural language processing (NLP). Recurrent Neural Networks (RNN) are another class of deep, feed-forward ANNs and are particularly useful at tasks such as, but not limited to, unsegmented connected handwriting recognition and speech recognition. Other types of neural networks are also known and can be used in accordance with one or more embodiments described herein.

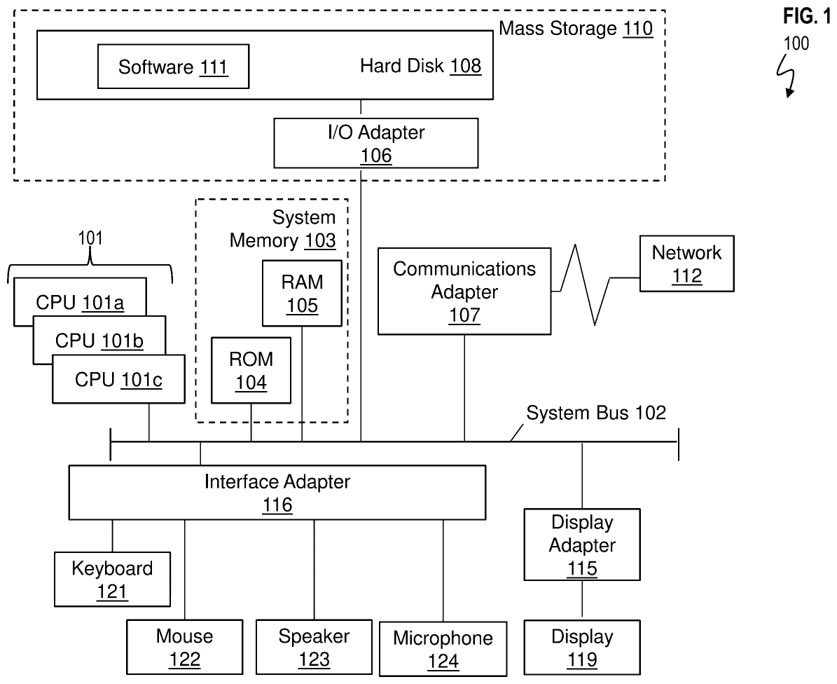

Turning now to FIG. 1, a computer system 100 is generally shown in accordance with one or more embodiments of the invention. The computer system 100 can be an electronic, computer framework comprising and/or employing any number and combination of computing devices and networks utilizing various communication technologies, as described herein. The computer system 100 can be easily scalable, extensible, and modular, with the ability to change to different services or reconfigure some features independently of others. The computer system 100 may be, for example, a server, desktop computer, laptop computer, tablet computer, or smartphone. In some examples, computer system 100 may be a cloud computing node. Computer system 100 may be described in the general context of computer system executable instructions, such as program modules, being executed by a computer system. Generally, program modules may include routines, programs, objects, components, logic, data structures, and so on that perform particular tasks or implement particular abstract data types. Computer system 100 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, the computer system 100 has one or more central processing units (CPU(s)) 101a, 101b, 101c, etc., (collectively or generically referred to as processor(s) 101). The processors 101 can be a single-core processor, multi-core processor, computing cluster, or any number of other configurations. The processors 101, also referred to as processing circuits, are coupled via a system bus 102 to a system memory 103 and various other components. The system memory 103 can include a read only memory (ROM) 104 and a random access memory (RAM) 105. The ROM 104 is coupled to the system bus 102 and may include a basic input/output system (BIOS) or its successors like Unified Extensible Firmware Interface (UEFI), which controls certain basic functions of the computer system 100. The RAM is read-write memory coupled to the system bus 102 for use by the processors 101. The system memory 103 provides temporary memory space for operations of said instructions during operation. The system memory 103 can include random access memory (RAM), read only memory, flash memory, or any other suitable memory systems.

The computer system 100 comprises an input/output (I/O) adapter 106 and a communications adapter 107 coupled to the system bus 102. The I/O adapter 106 may be a small computer system interface (SCSI) adapter that communicates with a hard disk 108 and/or any other similar component. The I/O adapter 106 and the hard disk 108 are collectively referred to herein as a mass storage 110.

Software 111 for execution on the computer system 100 may be stored in the mass storage 110. The mass storage 110 is an example of a tangible storage medium readable by the processors 101, where the software 111 is stored as instructions for execution by the processors 101 to cause the computer system 100 to operate, such as is described herein below with respect to the various Figures. Examples of computer program product and the execution of such instruction are discussed herein in more detail. The communications adapter 107 interconnects the system bus 102 with a network 112, which may be an outside network, enabling the computer system 100 to communicate with other such systems. In one embodiment, a portion of the system memory 103 and the mass storage 110 collectively store an operating system, which may be any appropriate operating system to coordinate the functions of the various components shown in FIG. 1.

Additional input/output devices are shown as connected to the system bus 102 via a display adapter 115 and an interface adapter 116. In one embodiment, the adapters 106, 107, 115, and 116 may be connected to one or more I/O buses that are connected to the system bus 102 via an intermediate bus bridge (not shown). A display 119 (e.g., a screen or a display monitor) is connected to the system bus 102 by the display adapter 115, which may include a graphics controller to improve the performance of graphics intensive applications and a video controller. A keyboard 121, a mouse 122, a speaker 123, a microphone 124, etc., can be interconnected to the system bus 102 via the interface adapter 116, which may include, for example, a Super I/O chip integrating multiple device adapters into a single integrated circuit. Suitable I/O buses for connecting peripheral devices such as hard disk controllers, network adapters, and graphics adapters typically include common protocols, such as the Peripheral Component Interconnect (PCI) and the Peripheral Component Interconnect Express (PCIe). Thus, as configured in FIG. 1, the computer system 100 includes processing capability in the form of the processors 101, storage capability including the system memory 103 and the mass storage 110, input means such as the keyboard 121, the mouse 122, and the microphone 124, and output capability including the speaker 123 and the display 119.

In some embodiments, the communications adapter 107 can transmit data using any suitable interface or protocol, such as the internet small computer system interface, among others. The network 112 may be a cellular network, a radio network, a wide area network (WAN), a local area network (LAN), or the Internet, among others. An external computing device may connect to the computer system 100 through the network 112. In some examples, an external computing device may be an external webserver or a cloud computing node.

It is to be understood that the block diagram of FIG. 1 is not intended to indicate that the computer system 100 is to include all of the components shown in FIG. 1. Rather, the computer system 100 can include any appropriate fewer or additional components not illustrated in FIG. 1 (e.g., additional memory components, embedded controllers, modules, additional network interfaces, etc.). Further, the embodiments described herein with respect to computer system 100 may be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

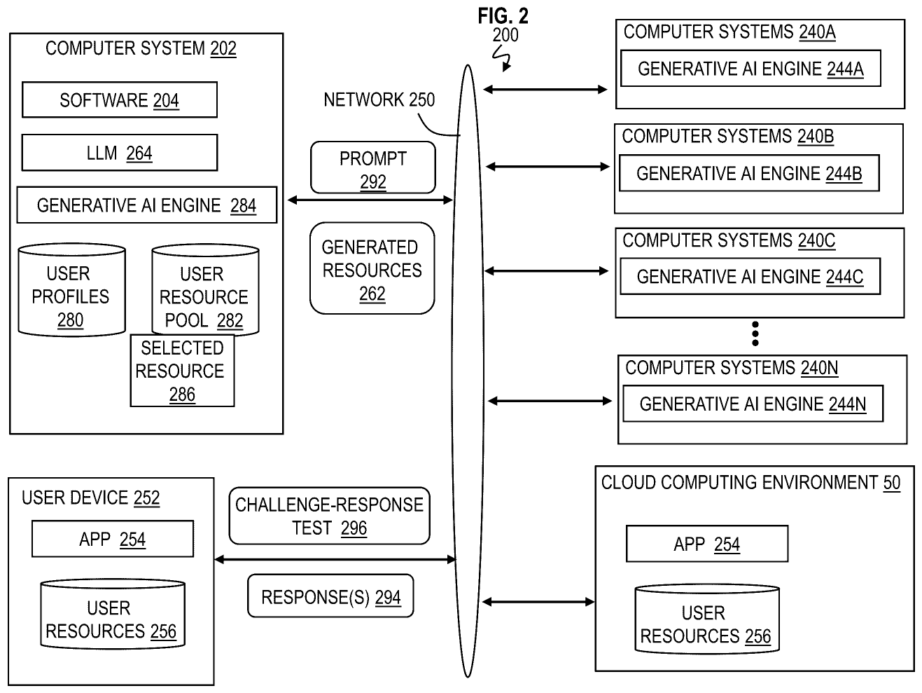

FIG. 2 depicts a block diagram of an example system 200 configured to dynamically perform user validation using local resources in order to permit or deny access to computer resources according to one or more embodiments. The system 200 includes a computer system 202 configured to communicate over a network 250 with many different computer systems, such as a computer system 240A, a computer system 240B, through a computer system 240N. The computer system 240A, the computer system 240B, through the computer system 240N can generally be referred to as computer systems 240.

The computer system 202 is configured to communicate with a user device 252 over the network 250. Although a single user device 252 is illustrated in FIG. 2, the user device 252 can represent numerous user devices connected to the computer system 202 for authentication and access services discussed herein. The user device 252 can be a personal computer or laptop. The user device 252 can be a mobile device such as a cellular phone or tablet, or a smart device. A smart device is an electronic device, generally connected to other devices or networks via different wireless protocols that can operate to some extent interactively. Several notable types of smart devices are smartphones, smart speakers, tablets, smartwatches, smart bands, smart glasses, and many others.

The network 250 can be a wired and/or wireless communication network, and the communication network includes a telecommunications network, the public switched telephone network (PTSN), voice over IP (VOIP) network, etc. The communication network includes cellular networks, satellite networks, etc.

The computer systems 240 can include various software and hardware components including software applications (apps) for communicating over the network 250 as understood by one of ordinary skill in the art. The computer systems 240A, 240B, 240C, and 240N can include generative AI engines 244A, 244B, 240C, and 244N, respectively to provide generative AI services. The generative AI engines 244A, 244B, 240C, and 244N can generally be referred to as generative AI engines 244.

The computer system 202, computer systems 240, user device 252, software 204, large language model (LLM) 264, software application 254, etc., can include functionality and features of the computer system 100 in FIG. 1 including various hardware components and various software applications such as software 111 which can be executed as instructions on one or more processors 101 in order to perform actions according to one or more embodiments of the invention. The software 204 can include, be integrated with, and/or call other pieces of software, algorithms, application programming interfaces (APIs), graphical user interfaces (GUIs), agents, etc., to operate as discussed herein.

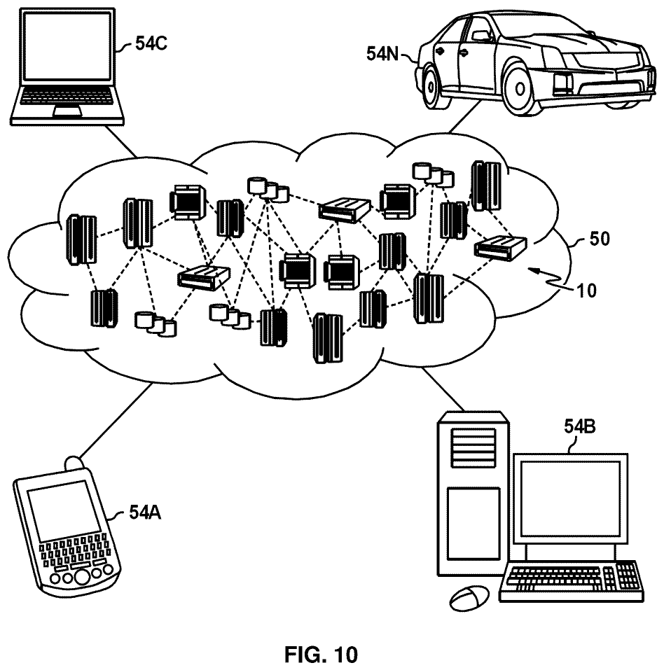

The computer system 202 may be representative of numerous computer systems and/or distributed computer systems configured to provide services to users of the user device 252. The computer system 202 can be part of a cloud computing environment such as a cloud computing environment 50 depicted in FIG. 10, as discussed further herein. In one or more embodiments, the computer system 202 can communicate with a cloud computing environment, like the cloud computing environment 50, on behalf of the user of user device 252 in order to access user resources 256.

Generative AI engines use generative artificial intelligence which is a type of AI that can create new content and ideas, including conversations, stories, images, videos, and music. AI technologies attempt to mimic human intelligence in nontraditional computing tasks like image recognition, natural language processing (NLP), and translation. Generative AI is trained to learn human language, programming languages, art, chemistry, biology, or any complex subject matter. Generative AI reuses training data to solve new problems. For example, it can learn the English vocabulary and create a poem from the words it processes. An organization can use generative AI for various purposes. Like any artificial intelligence, generative AI works by using machine learning models such as very large models that are pretrained on vast amounts of data. Examples of very large models can include foundation models and large language models.

Foundation models: Foundation models (FMs) are machine learning models trained on a broad spectrum of generalized and unlabeled data. Foundation models are capable of performing a wide variety of general tasks. Foundation models are the result of the latest advancements in a technology that has been evolving for decades. In general, a foundational model uses learned patterns and relationships to predict the next item in a sequence. For example, with image generation, the foundational model analyzes the image and creates a sharper, more clearly defined version of the image. Similarly, with text, the foundational model predicts the next word in a string of text based on the previous words and their context. The foundational model then selects the next word using probability distribution techniques.

Large language models: Large language models (LLMs) are one class of foundational models. LLMs are specifically focused on language-based tasks such as such as summarization, text generation, classification, open-ended conversation, and information extraction.

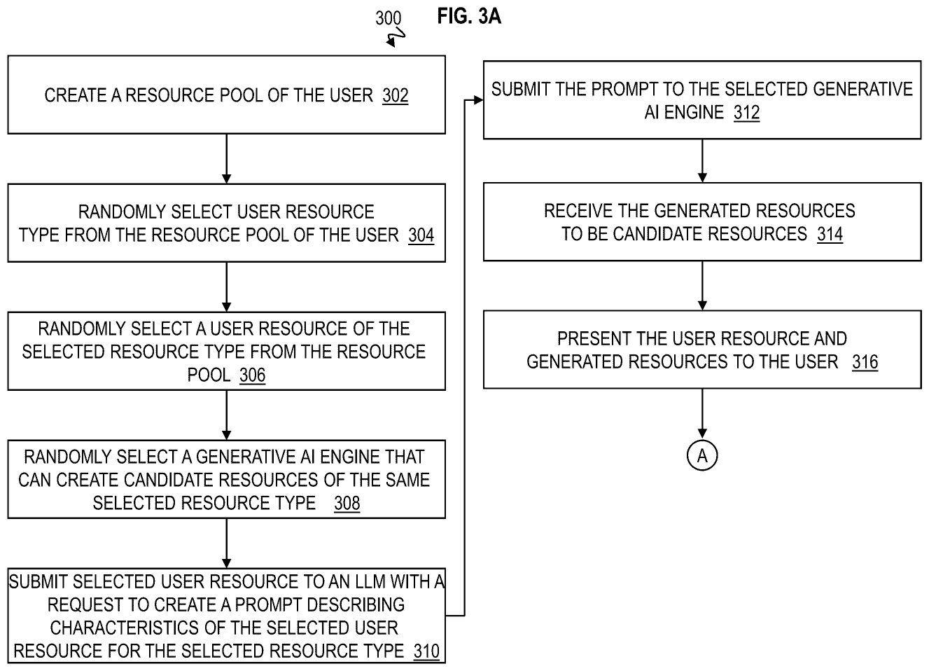

FIGS. 3A and 3B depict a flowchart of a computer-implemented method 300 for dynamically (in real-time or near real-time) performing user validation using local user resources or personal resources of the user in order to permit or deny access to computer resources according to one or more embodiments. The computer-implemented method 300 can be executed by the computer system 202 to validate the user of the user device 252 for access to computer resources or deny access to the computer resources. In one or more embodiments, the user device 252 can communicate, for example, in a client server relationship, with the computer system 202 in order to request access to one or more computer resources, which is a request for authentication. The requested computer resources can be hardware or software resources residing on and/or coupled to the computer system 202, a cloud computing environment like the cloud computing environment 50, the user device 252 itself, and/or any other computer system. In response to the request to access the computer resources, the computer system 202 can present a uniquely curated challenge-response test 296 to the user device 252 and receive a response from the user device 252 in order to authenticate the user. Reference can be made to any figures discussed herein.

At block 302 of the computer-implemented method 300, the software 204 of computer system 202 is configured to create a user resource pool 282 of user resources 256, which is part of ingestion. To create the user resource pool 282, the software 204 is configured to identify user resources in the user resources 256 of the user device 252 of a user and/or a cloud computing environment 50 associated with and/or belonging to the user. The user resources 256 can be of any resource type. Example resource types include but are not limited to audio, images, videos, calendar entries, files, etc. Additionally, resource types can include icons representing applications (apps) on the user device 252 and/or the cloud computing environment 50 belonging to the user. After identifying the user resources 256 of the user on the user device 252 and/or in the cloud computing environment 50 belonging to the user, the software 204 is configured to create the user resource pool 282 of the user resources. In one or more embodiments, the user resources 256 could be downloaded to thereby form the user resource pool 282. In one or more embodiments, pointers and/or memory addresses (including names) to the user resources 256 can be downloaded to form the user resource pool 282.

The computer system 202 has received an authentication request from the user of the user device 252. The authentication request may be a request to access one or more controlled computer resources. The system will now perform the execution phase.

At block 304, in response to an authentication request being made, the software 204 of the computer system 202 is configured to randomly select a resource type from the user resource pool 282. In one or more embodiments, more than one resource type can be selected. Any known method can be utilized for the random selection. The software 204 can utilize random selection algorithms or randomized algorithms to randomly select the resource type among the different resource types in the user resource pool 282. As discussed herein, example resource types of the user resource pool 282 may include but are not limited to audio, images, videos, calendar entries/events, files, icons, etc.

At block 306, in response to the authentication request being made, the software 204 of the computer system 202 is configured to randomly select a resource 286 from the user resource pool 282. Although one selected resource 286 is discussed for illustration, the software 204 can select more than one resource from the user resource pool 282. In one example, the software 204 may select a picture of my dog from the user resource pool 282 as the selected resource 286, in response to the selected resource type being an image. In another example, the software 204 may select my favorite song from the user resource pool 282 as the selected resource 286, in response to the selected resource type being audio. In one example, the software 204 may select a recurring entry/event on the calendar from the user resource pool 282 as the selected resource 286, in response to the selected resource type being calendar entries/events. It should be appreciated that any resource 286 corresponding to the selected resource type is randomly selected. When the selected resource type is audio, images, videos, calendar entries/events, files, or icons, the software 204 randomly selects the resource 286 from the user resource pool 282 having the same selected resource type.

At block 308, in response to the authentication request being made, the software 204 of the computer system 202 is configured to randomly select a generative AI engine that can create a resource that is of the same resource type of the selected resource 286. The software 204 can identify available generative AI engine in advance, which can include internal generative AI engines such as generative AI engine 284 and external generative AI engines such as generative AI engines 244. The random selection of the generative AI engine further increase security and prevents reverse engineering of the authentication method. Example generative AI engines include but are not limited to ChatGPT for text output, Midjourney for image output, Runway for video output, etc.

At block 310, the software 204 of the computer system 202 is configured to use a large language model to create a prompt 292 that is to be utilized for creating artificial resources of the selected resource type (e.g., audio, images, videos, calendar entries/events, files, icons, etc.). For example, the selected resource 286 is input to the LLM 264 along with a request to characterize the selected resource 286, such that the LLM 264 outputs a description of the selected resource 286 as the prompt 292. If there is any metadata (including tags) associated with the selected resource 286 such as my favorite cat, the software 204 can parse the metadata to be utilized input to the LLM 264 and/or for use in creation of a challenge question for the user. There can be different types of LLM 264 where one LLM 264 is more suited for one type of resource type than another type of resource type. In one or more embodiments, the description of the selected resource 286 can be generated user a reverse image search, such as, for example, Lexica art.

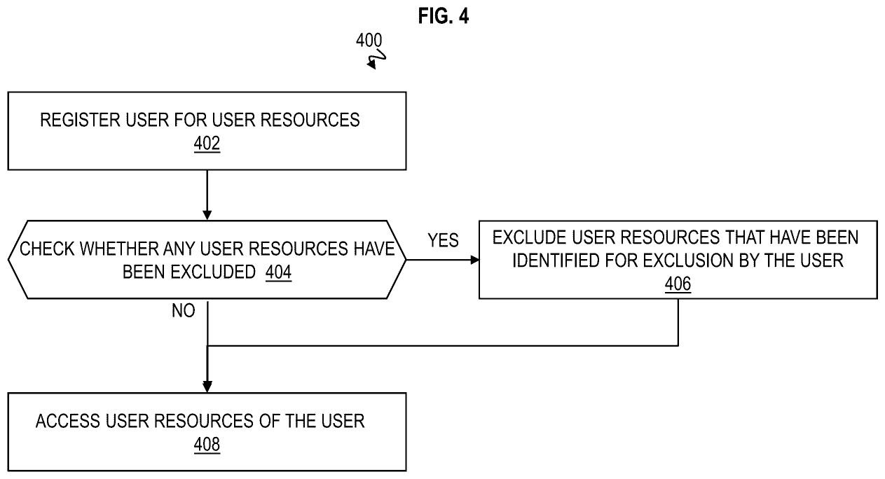

FIG. 5 depicts an example of a selected resource 286 of the selected resource type. In this example, the selected resource type is an image, and the selected resource 286 is the original image of a cat from the user device 252 and/or the cloud computing environment 50 of the user. After inputting the selected resource 286 to the LLM 264 along with a request to generate a prompt to create the image and/or describe the image, the LLM 264 outputs the prompt 292. In FIG. 5, the example prompt 292 is “create a cute cat, realistic, detailed, clear image, blurred background.”

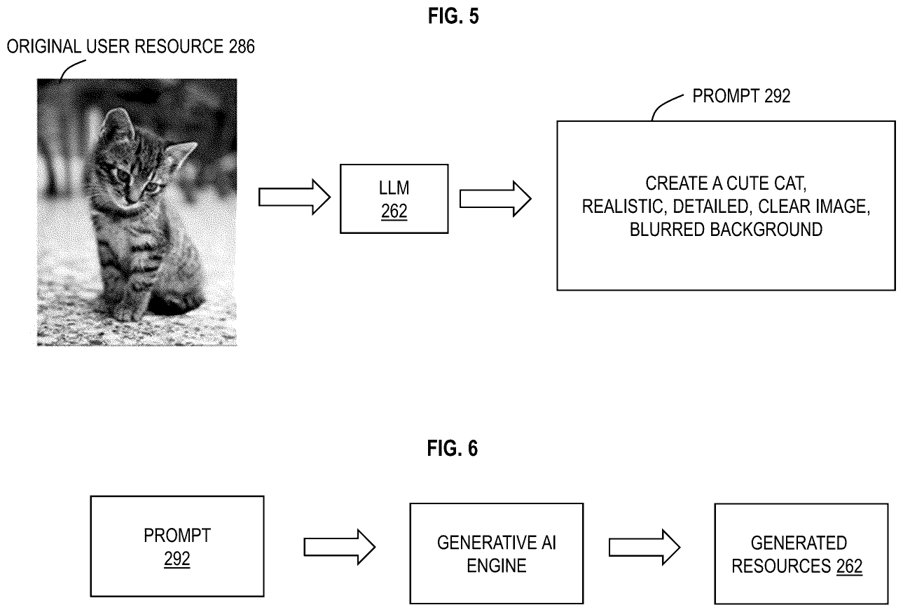

Referring to FIG. 3A, at block 312, the software 204 of the computer system 202 is configured to submit the prompt to the selected generative AI engine (e.g., any of the external generative AI engines 244 and/or internal generative AI engines 284) that support supports the selected resource type. The submission is an anonymous submission of the prompt 292, which causes execution of the generative AI engine. The prompt 292 can request that a predefined number of generated resources 262 be output by the generative AI engine. The prompt 292 can be submitted a predefined number of times to achieve the desired number of generated resources 262 output by the generative AI engine. FIG. 6 depicts a block diagram of an example of the prompt 292 being submitted to the selected generative AI engine in order to generate output of the generated resources 262. The generated resources 262 are artificial resources having the same resource type as and characteristics of the original user resource 286.

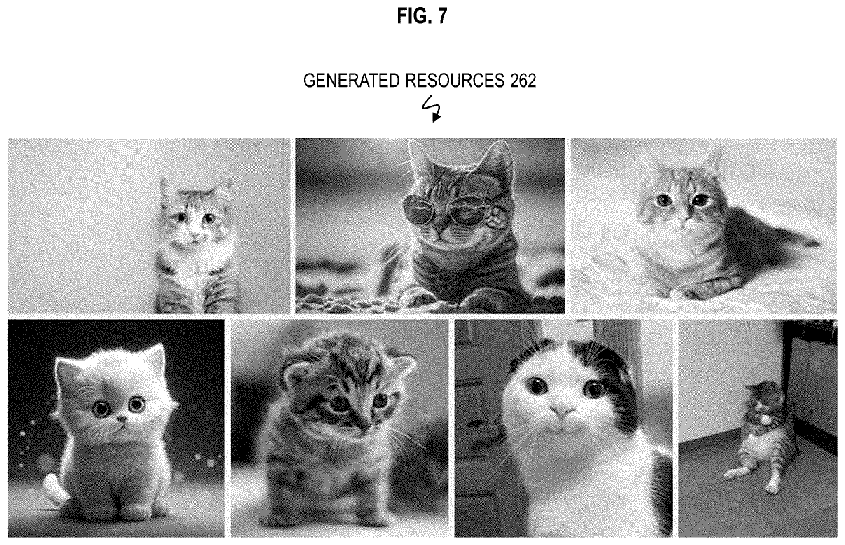

At block 314, the software 204 of the computer system 202 is configured to receive an output of the generated resources 262 (e.g., audio, images, videos, calendar entries/events, files, and/or icons) from the selected generative AI engine. In an example scenario, the selected user resource 286 can be the image of a cat as illustrated in FIG. 5. Accordingly, the prompt 292 is sent to the selected generative AI engine to create the generated resources 262, which are depicted as cats in FIG. 7. The generated resources 262 of cats represent candidate resources from which the user can select. In this example, 7 generated resources 262 were created as distractors. More or fewer artificial resources can be utilized.

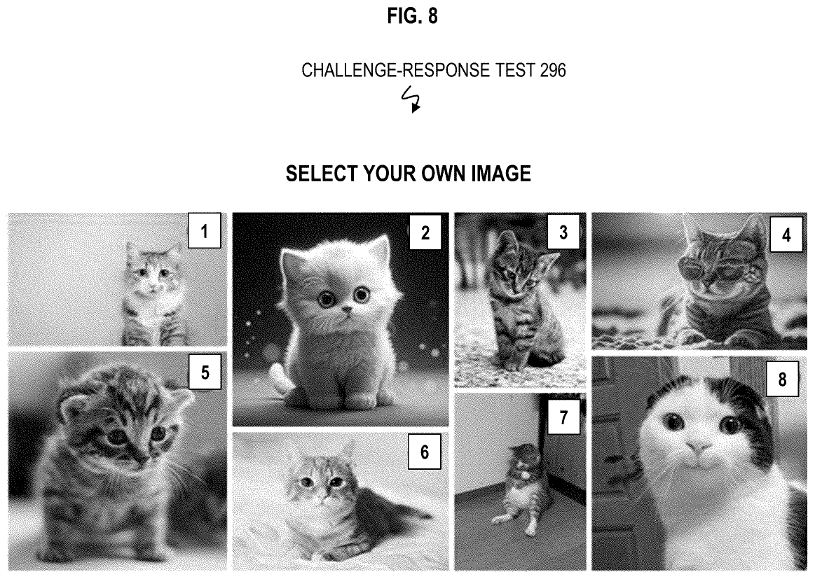

At block 316, the software 204 of the computer system 202 is configured to present the generated resources 262 and the selected user resource 286 to the user for validation as a challenge-response test 296 in order to receive a response 294 of the user from the user device 252. FIG. 8 depicts an example challenge-response test 296 of the original user resource 286 along with the generated resources 262 for the user to select the correct image. The challenge-response test 296 can be displayed on the display of the user device 252 for selection by the user. For example, the challenge-response test 296 asks the user to “select your own image.” Using a graphical user interface and/or any type of selection method including audio, gestures, tactile, etc., the user can make a selection of the desired image. It is noted that number 3 is the correct answer based on the original user resource in FIG. 5, while the other images are incorrect. The original user resource 286 and the generated resources 262 may be displayed as selectable objects. Although the selected resource type is illustrated as an image, the selected resource type could be audio. Accordingly, the original user resource is an audio file, and the generated resources are other audio files artificially generated as distractors. After playing the audio files of the original user resource and the generated resources, the user has to select the original user resource.

Referring to FIG. 3B, at block 318, the software 204 of the computer system 202 is configured to check whether the response 294 received from the user is the correct user resource 286 or one of the generated resources 262.

At block 320, in response (YES) to the response 294 being the correct user resource 286, the software 204 of the computer system 202 is configured to permit access to the protected computer resource. As discussed herein, the protected computer resources can include hardware and/or software resources residing on and/or coupled to the computer system 202, the cloud computing environment 50, the user device 252 itself, and/or any other computer system.

At block 322, in response (NO) to the response 294 not being the correct user resource 286, the software 204 of the computer system 202 is configured to deny access to the protected computer resource. When the user is denied access because the user fails to recognize the selected resource 286 as the correct answer (by instead selecting one or the generated resources 262), the software 204 can cause one or more security actions to be executed. The security actions include locking the user out of the protected computer resource (such as an application, a website, a protected database, a repository, an account, a computer system, a computer-based service, etc.), requesting multi-factor authentication (MFA), executing another authentication method, executing the same process again (in FIGS. 3A and 3B) in order to offer the user another challenge-response test with a different user resource and/or different resource type, etc. The selection of the security actions can be done manually by the user (in advance) and/or can be automated based on the user profile, preferences, account type, location, etc.

In one or more embodiments, the software application 254 on the user device 252 and/or a computing system in the cloud computing environment 50 can be configured as and/or include a secure monitoring agent. In one or more embodiments, the secure monitoring agent can be triggered for execution upon presentation of the challenge-response test 296 to the user. In one or more embodiments, the secure monitoring agent can be triggered for execution prior to presentation of the challenge-response test 296 to the user. The secure monitoring agent is configured to monitor for any local file system searches, for example, on the user device 252 and/or the user space of the cloud computing environment 50. If the secure monitoring agent detects a file system search, then the secure monitoring agent can execute a security subsystem that includes but is not limited to: locking the user out, sending an alert message, resetting authentication, and requesting MFA. An attacker may compromise the victim's device (which can include physical access and/or remote access) and perform a search to find/validate the correct response by checking the images on the local user device 252. Therefore, having the secure monitoring agent increases the security and effectiveness of the authentication by anticipating the attacker's attempt to search and find the correct response.

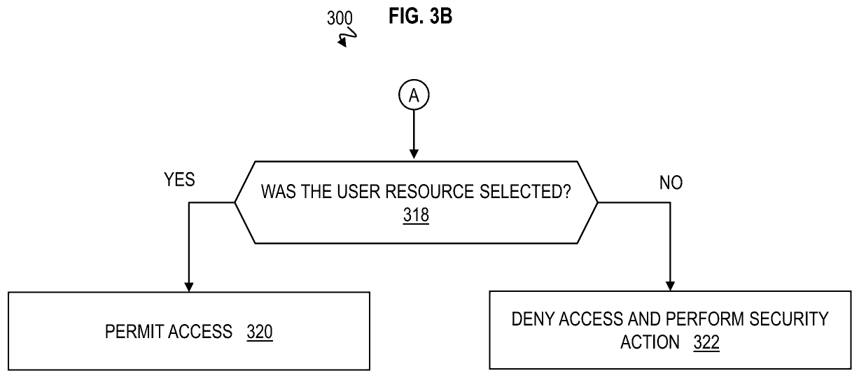

FIG. 4 is a block diagram of a computer-implemented method 400 for setup and/or registration according to one or more embodiments. In one or more embodiments, the setup may be in advance. In one or more embodiments, the setup may occur during the authentication. At block 402, the software 204 is configured to receive a request to register the user resources 256 for authentication. The software 204 is configured to ask the user to select any user resources that should be included for authentication and/or any user resources that should be excluded. In some cases, it may be more efficient for the user to identify those user resources suitable for authentication. At block 404, the software 204 is configured to check if any user resources are to be excluded from authentication. At block 406, the software 204 is configured to exclude user resources that have been identified for exclusion by the user. At block 408, the software 204 is configured to access the user resources of the user, which were not excluded in order to provide authentication services discussed herein. Accessing the user resources 256 is utilized to create the user resource pool 282.

After receiving prior permission, the software 204 may parse the user resources 256 of the user device and/or user space of the cloud computing environment 50. In one or more embodiments, a software application 254 can be downloaded in advance on the user device 252 and/or in the cloud computing environment 50 belonging to the user. The software application 254 is configured to parse and retrieve the user resources 256 on the user device 252 and/or the cloud computing environment 50, and provide the user resources 256 to the software 204 of computer system 202 for the user resource pool 282.

In one or more embodiments, the user identifies in advance which user resources 256 can be used for authentication and which user resources 256 are restricted from being used for authentication. For example, user can utilize the software application 254, access a web browser provided by the software 204, etc., in order to select the folder(s) of images that can be used, the documents that can be used, the audio that can be used, the videos that can be used, the files that can be used, etc. In one or more embodiments, the user can select the restricted images, restricted documents, restricted audio, restricted videos, restricted icons, etc., that are not to be used for authentication, while other user resources are available. This prevents the software 204 from using private or sensitive resources during the authentication. In one or more embodiments, the user and/or the software application 254 can created a dedicated file for authentication such that user resources 256 identified, pointed to, and/or saved in the dedicated file are utilized for authentication, while other user resources are restricted from use; the dedicated file can be saved as the user resource pool 282. It should be appreciated that any combination of selecting and restricting user resources 256 may be implemented in order to create the user resource pool 282. Although the user resource pool 282 is shown coupled to the computer system 202, in one or more embodiments the user resource pool 282 can be on the user device 252, the cloud computing environment 50, etc.

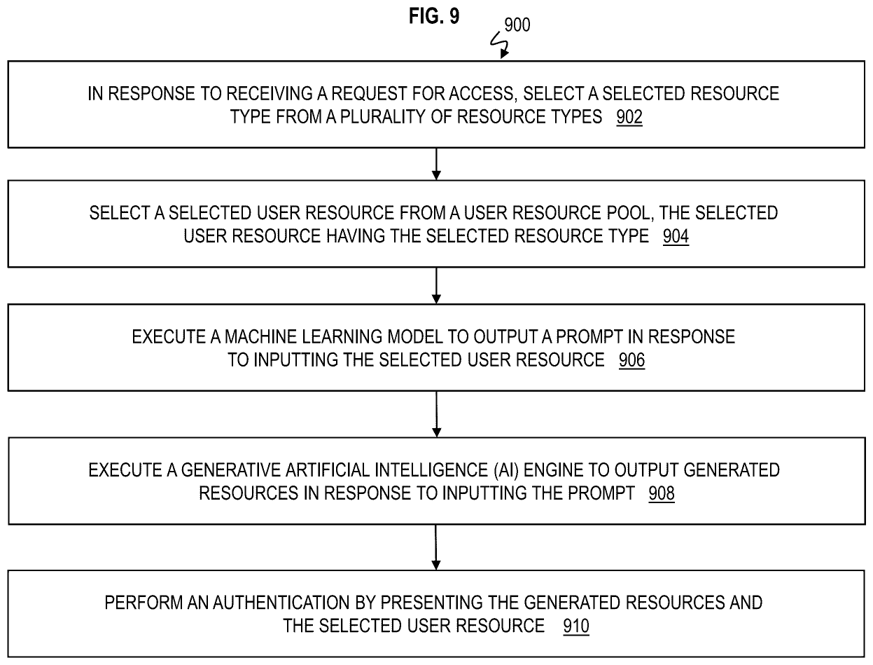

FIG. 9 is a flowchart of a computer-implemented method 900 for performing user validation using local resources in order to permit or deny access to computer resources according to one or more embodiments. Reference can be made to any of the figures discussed herein.

At block 902, the computer system 202 is configured to in response to receiving a request for access to a computer resource, select a selected resource type from a plurality of resource types. At block 904, the computer system 202 is configured to select a selected user resource 286 from a user resource pool 282, the selected user resource 286 having the selected resource type. At block 906, the computer system 202 is configured to execute a machine learning model (e.g., LLM 264) to output a prompt 292 in response to inputting the selected user resource 286. At block 908, the computer system 202 is configured to execute a generative artificial intelligence (AI) engine (e.g., generative AI engines 244 and/or 284) to output generated resources 262 in response to inputting the prompt 292. At block 910, the computer system 202 is configured to perform an authentication by presenting the generated resources 262 (as distractors) and the selected user resource 286.

In one or more embodiments, the computer system 202 is configured to, in response to receiving a selection of the selected user resource 286 for the authentication, grant the access to computer resources. The computer system 202 is configured to, in response to receiving a selection of at least one of the generated resources for the authentication, deny the access to computer resources. The computer system 202 is configured to, in response to receiving a selection of at least one of the generated resources 262 for the authentication, perform a security action.

According to one or more embodiments, the generated resources 262 have the selected resource type the same as the selected user resource 286. The selected user resource 286 is perceptible by at least one of a plurality of human senses (e.g., vision, hearing, touch, smell, etc.), and the generated resources are equally perceptible by the same one(s) of the at least one of the plurality of human senses as the selected user resource 286. The computer system 202 is configured to cause monitoring (e.g., via a software application 254) of a user device 252 from which the user resource pool 282 was derived. The computer system 202 is configured to, in response to detecting an attempt to search (e.g., via a software application 254) the user device 252 during the authentication, perform a security action.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

### Service Models are as Follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

### Deployment Models are as Follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 10, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described herein above, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 10 are intended to be illustrative only and that computing nodes 10 and cloud computing environment 50 can communicate with any type of computerized device over any type of network and/or network addressable connection (e.g., using a web browser).

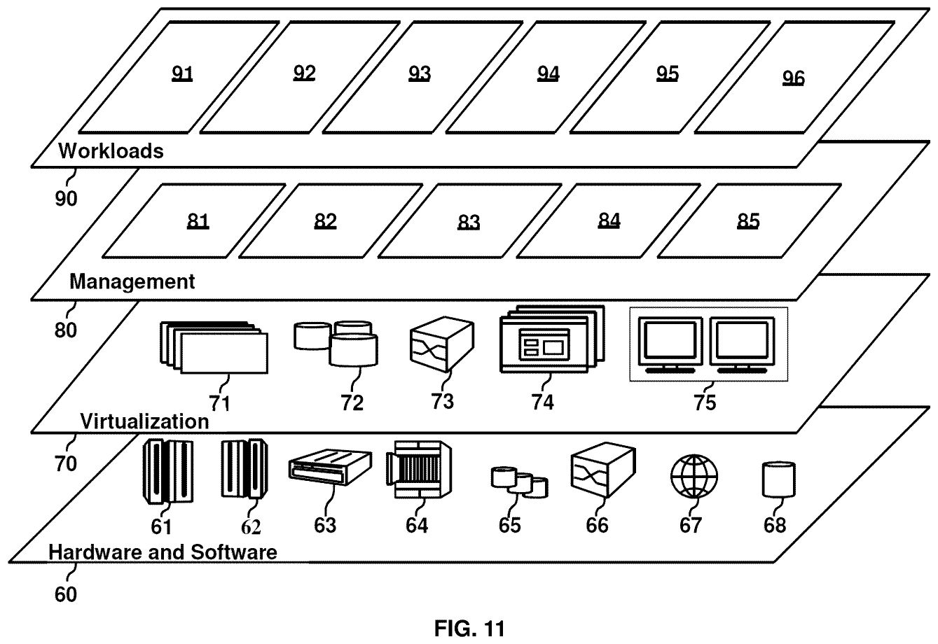

Referring now to FIG. 11, a set of functional abstraction layers provided by cloud computing environment 50 (depicted in FIG. 10) is shown. It should be understood in advance that the components, layers, and functions shown in FIG. 11 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and workloads and functions 96. Aspects of embodiments may be implemented/executed, at least in part, as the workloads and functions 96. In one or more embodiments, the software 204, LLM 264, generative AI engine 284, and/or software application 254 can be executed as one of the workloads and functions 96.

Various embodiments of the present invention are described herein with reference to the related drawings. Alternative embodiments can be devised without departing from the scope of this invention. Although various connections and positional relationships (e.g., over, below, adjacent, etc.) are set forth between elements in the following description and in the drawings, persons skilled in the art will recognize that many of the positional relationships described herein are orientation-independent when the described functionality is maintained even though the orientation is changed. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. As an example of an indirect positional relationship, references in the present description to forming layer “A” over layer “B” include situations in which one or more intermediate layers (e.g., layer “C”) is between layer “A” and layer “B” as long as the relevant characteristics and functionalities of layer “A” and layer “B” are not substantially changed by the intermediate layer(s).

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted, or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method comprising:
in response to receiving a request for access, selecting a selected resource type from a plurality of resource types;
selecting a selected user resource from a user resource pool, the selected user resource having the selected resource type;
executing a machine learning model to output a prompt in response to inputting the selected user resource;
causing execution of a generative artificial intelligence (AI) engine to output generated resources in response to inputting the prompt; and
performing an authentication by presenting the generated resources and the selected user resource.

2. The computer-implemented method of claim 1, further comprising, in response to receiving a selection of the selected user resource for the authentication, granting the access.

3. The computer-implemented method of claim 1, further comprising, in response to receiving a selection of at least one of the generated resources for the authentication, denying the access.

4. The computer-implemented method of claim 1, further comprising, in response to receiving a selection of at least one of the generated resources for the authentication, performing a security action.

5. The computer-implemented method of claim 1, wherein the generated resources have the selected resource type a same as the selected user resource.

6. The computer-implemented method of claim 1, wherein the selected user resource is configured to be perceptible by at least one of a plurality of human senses, the generated resources being equally perceptible by the at least one of the plurality of human senses.

7. The computer-implemented method of claim 1, further comprising causing monitoring of a user device from which the user resource pool was derived.

8. The computer-implemented method of claim 7, further comprising in response to detecting an attempt to search the user device during the authentication, performing a security action.

9. A system comprising:
a memory having computer readable instructions; and
one or more processors for executing the computer readable instructions, the computer readable instructions when executed cause the one or more processors to perform operations comprising:
in response to receiving a request for access, selecting a selected resource type from a plurality of resource types;
selecting a selected user resource from a user resource pool, the selected user resource having the selected resource type;
executing a machine learning model to output a prompt in response to inputting the selected user resource;
causing execution of a generative artificial intelligence (AI) engine to output generated resources in response to inputting the prompt; and
performing an authentication by presenting the generated resources and the selected user resource.

10. The system of claim 9, wherein the one or more processors perform operations further comprising, in response to receiving a selection of the selected user resource for the authentication, granting the access.

11. The system of claim 9, wherein the one or more processors perform operations further comprising, in response to receiving a selection of at least one of the generated resources for the authentication, denying the access.

12. The system of claim 9, wherein the one or more processors perform operations further comprising, in response to receiving a selection of at least one of the generated resources for the authentication, performing a security action.

13. The system of claim 9, wherein the generated resources have the selected resource type a same as the selected user resource.

14. The system of claim 9, wherein the selected user resource is configured to be perceptible by at least one of a plurality of human senses, the generated resources being equally perceptible by the at least one of the plurality of human senses.

15. The system of claim 9, wherein the one or more processors perform operations further comprising causing monitoring of a user device from which the user resource pool was derived.

16. The system of claim 15, wherein the one or more processors perform operations further comprising in response to detecting an attempt to search the user device during the authentication, performing a security action.

17. A computer program product comprising a computer readable storage medium having program instructions embodied therewith, the program instructions executable by one or more processors to cause the one or more processors to perform operations comprising:
in response to receiving a request for access, selecting a selected resource type from a plurality of resource types;
selecting a selected user resource from a user resource pool, the selected user resource having the selected resource type;
executing a machine learning model to output a prompt in response to inputting the selected user resource;
causing execution of a generative artificial intelligence (AI) engine to output generated resources in response to inputting the prompt; and
performing an authentication by presenting the generated resources and the selected user resource.

18. The computer program product of claim 17, further comprising, in response to receiving a selection of the selected user resource for the authentication, granting the access.

19. The computer program product of claim 17, further comprising, in response to receiving a selection of at least one of the generated resources for the authentication, denying the access.

20. The computer program product of claim 17, further comprising, in response to receiving a selection of at least one of the generated resources for the authentication, performing a security action.
